(19) United States
(12) Patent Application Publication
(10) Pub. No.: US 2010/0210253 A1
(43) Pub. Date: Aug. 19, 2010

(54) Cellular telephone audience appreciation display signalling

(76) Inventor: Dan Joseph Brown, Long Beach, CA (US)

Correspondence Address: JOHN BERRYHILL, 4 WEST FRONT STREET, MEDIA, PA, 19063, US

(21) Appl. No.: 12/655,207

(22) Filed: Dec. 24, 2009

Related U.S. Application Data
(60) Provisional application No. 61/140,866, filed on Dec. 25, 2008.

(51) Int. Cl. H04M 3/00; H04M 1/00

(52) U.S. Cl. 455/418; 455/566

(57) ABSTRACT

A cellular telephone is programmed to provide a user input menu for presenting a list of visual signals, from which a user may select one of the signals to be displayed on the screen of the telephone. Such visual signals as monochromatic color displays, national flags, or team emblems or colors may be selected in order to signal appreciation at mass events such as concerts and sporting contests.

### RELATED APPLICATION

Priority under 35 U.S.C. §119 is claimed herein to U.S. Application No. 61/140,866 filed Dec. 25, 2008, and which is incorporated as if fully set forth herein.

### BACKGROUND

Years ago, cigarette lighters were the symbol for audience connection with performers or athletes at large events. Currently at such events, attendees use the backlight of their cellular phone to interact with the music and the audience. Most of these phones just have the standard, dim, white background with a default informational display for normal use of the phone. This makes the action dull and ineffective.

### SUMMARY OF THE INVENTION

The present invention includes a method to allows a cell phone user to select the backlight color of their phone in order to participate more expressively at concerts and events. This function can be used by anyone who desires a more vibrant, colorful, mobile phone screen. The present invention intensifies audience participation experience by providing a full-screen brighter backlight than the default cell phone display screen and an available array of colors, patterns or animations to be displayed at different types of events, depending on the user's preferences.

### DESCRIPTION OF THE DRAWING

The foregoing summary, as well as the following Detailed Description, will best be understood with reference to the attached drawings in which:

FIG. 1. is a system diagram of the present invention.

FIG. 3 is a sequential flow diagram of the method of the invention.

FIG. 3 is a depiction of a phone operating in accordance with an embodiment of the invention.

### DETAILED DESCRIPTION

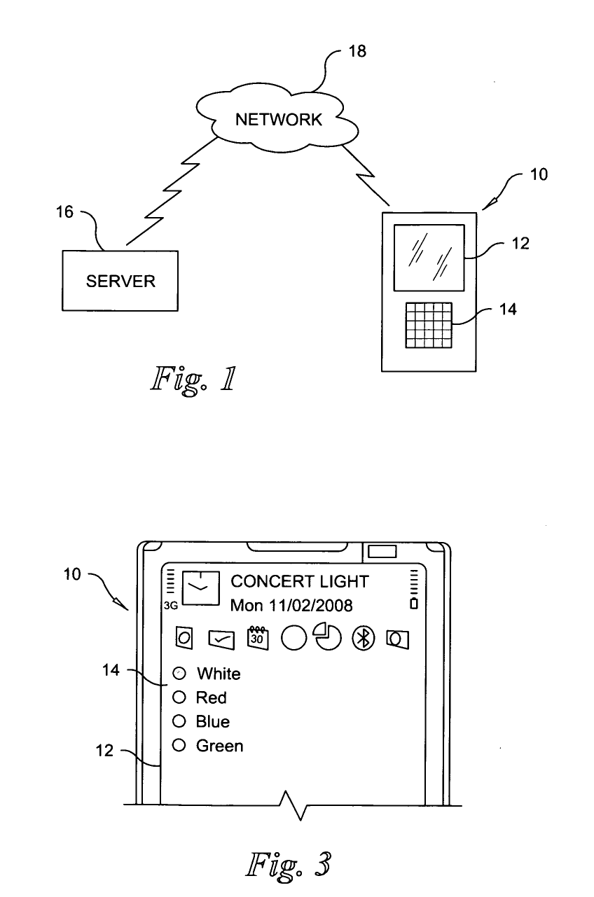

Referring now to FIG. 1, there is shown a cell phone 10 of the type having a display screen 12. The cell phone includes a processor and memory (not shown) and a display driver (not shown), such that the processor is programmable to produce informational and graphic images on the display screen 12. The cell phone further comprises a user input device, such as a keypad 14, touch screen, trackball, or other such user input device known in the art. During ordinary operation, the screen 12 is used to show graphics and text relating to operation of the cell phone for communication purposes. In accordance with the present invention, a downloadable program is provided on a remote server 16 from which the user may download a program via network 18 into the memory of cell phone 10 to effect the method of the invention. In the preferred embodiment, the software is provided in the form of a JAVA/J2ME program compatible with JAVA-enabled telephones and Symbian OS devices such as those manufactured by Nokia, Sony Ericsson, Samsung, LG. Alternative software versions can be provided in objective C for porting to the Apple iPhone, and other “smart phone” devices. In other embodiments, the software may be downloaded from another device, such as via the Bluetooth protocol or other local network technology deployed at the event being attended by the user, or upon a “hard” medium such as a flash memory device.

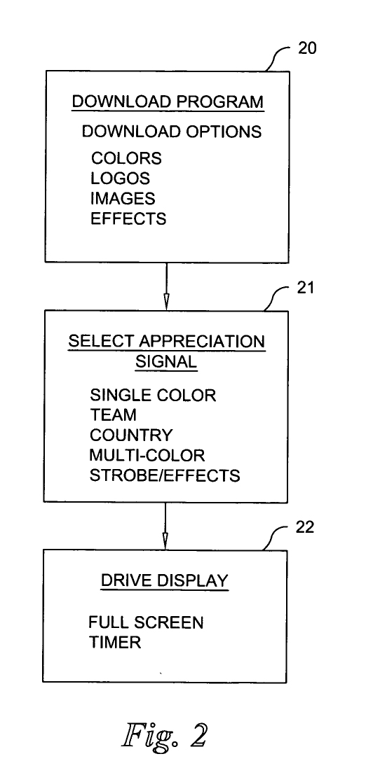

Execution of one embodiment of the method of the invention is shown in FIG. 2. The server 16 may be configured for access by the phone 10 and to provide multiple download options at the time of downloading the software, such as a range of colors, logos, images, or effects. Upon selecting to download the software and any options or plug-ins desired, the user may then launch the program to run on the phone 10, at step 21. In step 21, a menu 14 of appreciation signals, such as individual colors according to one embodiment shown in FIG. 3, is shown to the user on the display. The user may then selects one of the colors from the menu. Color options include red, yellow, green, blue, purple, orange, pink, white, etc. In other embodiment, the user may select intensity variation options such as a strobe function to flash or otherwise vary the intensity of the selected signal repeatedly at a selectable speed.

After the user has completed selected an appreciation signal and options from the menu 14, in step 22, the processor controls the display driver to display the selected appreciation signal across substantially the entire area of the display. Display of the appreciation signal may further be carried out for a selected period of time. In an embodiment wherein the appreciation signal is a single color, the display is driven to provide a substantially monochromatic blank screen in the selected color. Alternatively, in embodiments wherein the menu provides selection of multiple colors, the display is driven to provide a substantially monochromatic blank screen sequentially in each of the colors. If an intensity variation option was selected, then the processor controls the display driver to cause the display to operate in accordance with the selected intensity variation option.

In yet other embodiments, the selection menu may include a selection of teams, countries, or other groups which the user admires and desires to show appreciation. In such embodiments, the selection menu may include a list of teams or countries as either a text list or by displaying a particular logo or flag associated with the group. Selected teams, countries or groups may be specified at the time the program is downloaded to provide a configurable user selection menu during execution of the program. In instances where a group is associated with one or more colors, the color(s) associated with the group are stored in the memory, and the associated color or color sequence is retrieved by the processor after the group is selected from the menu in order to control the display driver to produce a display of the appreciation signal during the display step of the method. Such associated colors are preferably the team colors or national colors, such as red, white and blue for the United States.

Alternatively, or in addition to displaying a substantially monochromatic display or sequence of displays across the entire face of the screen, an image file constituting a figurative logo may be downloaded in association with a selection of groups. In the case of sports teams, such an image file may be a team logo or a logo associated with a performing group. Such teams may include national or regional teams, and the image file may correspond to the flag of such nation or region, such that the selected logo or flag is shown on the screen, with optionally selected intensity variation during the display step.

The foregoing description is intended by way of example to describe the preferred embodiments of the invention. Other variations and modifications will be rendered apparent hereby, within the scope of the claims hereof.

What is claimed is:

1. A method of signaling audience appreciation, using a cell phone having a display, comprising the steps of:
providing a user input menu for presenting a list of appreciation signals;
selecting a desired appreciation signal from the menu; and
operating the cell phone to display the selected appreciation signal;

2. The method of claim 1 in which the step of providing a user input menu comprises providing a list of selectable colors and the step of operating the cell phone to display the selected appreciation signal comprises the step of driving the display to show a substantially blank monochromatic screen in a selected color.

3. The method of claim 2 in which the step of driving the display includes varying the brightness of the screen to provide a flashing effect.

4. The method of claim 1 in which the step of providing a user input menu comprises providing a list of selectable colors, wherein the step of selecting a desired appreciation signal comprises specifying a plurality of colors, and said step of operating the cell phone to display the selected appreciation signal comprises the step of driving the display to sequentially show a substantially blank monochromatic screen in each of the plurality of colors.

5. The method of claim 1 in which the step of providing a user input menu comprises providing a list of teams, wherein each team is associated with at least one color, and said step of step of driving the display comprises the step of driving the display to show a substantially blank monochromatic screen in the color associated with a selected team.

6. The method of claim 5 in which at least one team is associated with more than one color, and said step of driving the display comprises the step of driving the display to sequentially show a substantially blank monochromatic screen in each of the colors associated with a selected team.

7. The method of claim 6 in which the step of providing a list of teams comprises displaying a logo associated with each team.

8. The method of claim 6 in which said at least one team corresponds to a country, and said more than one color corresponds to the national colors of the country.

9. The method of claim 1 in which the step of providing a user input menu comprises providing a list of figurative logos, and wherein the step of driving the display comprises the step of displaying a selected logo on substantially all of the screen.

10. The method of claim 8 in which the list of figurative logos include national flags.

11. The method of claim 1 in which the list of appreciation signals includes a list of sequential time varying patterns, and the step of driving the display includes showing a selected one of said patterns across substantially all of the display.

12. The method of claim 1 including the initial step of downloading a configurable list of appreciation signals from a remote server.

13. The method of claim 1, further comprising the steps of distributing at an event to be attended by an audience, downloadable software for effecting the steps of providing said user input menu, selecting the appreciation signal and operating the cell phone to display the selected appreciation signal.

14. The method of claim 13, wherein said distributing step comprises providing a local network at an event attended by an audience, and storing, on a server connected to said local network, downloadable software.
